(19) United States
(12) Patent Application Publication
(10) Pub. No.: US 2016/0191337 A1
(43) Pub. Date: Jun. 30, 2016

(54) VISUALIZED DEVICE INTERACTIVITY MANAGEMENT

(71) Applicant: Intel Corporation, Santa Clara, CA (US)

(72) Inventor: RYAN P. SCHIEWE, Silverton, OR (US)

(73) Assignee: Intel Corporation, Santa Clara, CA (US)

(21) Appl. No.: 14/582,249

(22) Filed: Dec. 24, 2014

(51) Int. Cl. H04L 12/24; G06F 3/0484; G06F 3/14; G06F 3/0488

(52) U.S. Cl. CPC H04L 41/22; G06F 3/04883; G06F 3/04842; G06F 3/1423

(57) ABSTRACT

The present disclosure is directed to a visualized device interactivity management system. A device may display visual representations of target devices with which wireless interaction is possible. Advertising signals may be received from the target devices, the advertising signal being used to determine target device location and may also include target device data that may overlay the visual representations of the target devices. A user may interact with the device to cause activities to be performed with the target devices. For example, the device may display indicia of selection for visually selecting at least one of the target devices. The device may also comprise a touch-sensitive display. For example, a user may draw a gesture on the display including at least one of the target devices, which may cause the device to then perform an activity related to at least the target devices included within the drawn gesture.

### TECHNICAL FIELD

The present disclosure relates to electronic communication, and more particularly, to a system that provides a visualized interface through which device interactivity may be managed.

### BACKGROUND

Modern technology is increasingly becoming “connected.” People may employ a variety of devices to perform daily activities. Initially there are primary data processing devices such as, but not limited to, desktop computers, laptop computers, tablet computers, smart phones, etc. In common practice these devices may connect to a wide-area network (WAN) such as the Internet over which a variety of applications may exchange data related to functionality desired by a user. These devices do not act alone. In addition to interacting with each other via the Internet or via a local-area network (LAN), there are now a multitude of peripheral devices that may be integrated into the user experience. Users may desire audio or visual enhancement that may be achieved by wirelessly connecting to wireless external speakers, wireless-enabled monitors (e.g., televisions, projectors etc.), etc. Interaction with modern technology may be made more convenient through the use of external user input devices that connect wirelessly to a primary data processing device, including a variety of emerging “wearable” devices (e.g., smart eyewear, wristwatch form-factor devices, exercise monitoring devices, etc.) that may facilitate device interaction while the user is involved in activities that would not usually be conducive to such interaction. Moreover, close-proximity wireless interaction (e.g., within a few inches) is now being adopted in lieu of material money to execute financial transactions such as buying meals, groceries, consumer products, etc.

While the end benefit of such interactivity is apparent, establishing and maintaining these networks may be a challenge. For example, a user may employ a group of devices that interact via at least one wireless LAN (WLAN), and at least one of the devices may also be active on a WAN. This would be fine if this architecture stayed static, but often devices are reconfigured, disconnected, reconnected, etc., depending on the nature of use. For example, at home a wireless speaker may be coupled to a WLAN for use in playing music stored on a laptop computer, but the wireless speaker may then be disconnected and reconnected to a smart phone via Bluetooth when a user is outside of the home. Given existing user interface technology, establishing and maintaining these connections may be a substantial challenge for novice users, and may simply be inconvenient for experienced users. In either case, a reduced quality of experience may result.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example system for visualized device interactivity management in accordance with at least one embodiment of the present disclosure;

FIG. 2 illustrates example configurations for a device and at least one target device in accordance with at least one embodiment of the present disclosure;

FIG. 3 illustrates an alternative system for visualized device interactivity management in accordance with at least one embodiment of the present disclosure;

FIG. 4 illustrates example operations for wireless device visualization in accordance with at least one embodiment of the present disclosure; and

FIG. 5 illustrates example operations for visualized activity execution in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

The present disclosure is directed to a visualized device interactivity management system. In at least one embodiment, a device may display visual representations of target devices with which wireless interaction is possible. For example, advertising signals may be received from the target devices, the advertising signal being used to determine target device location and may also include target device data that may overlay the visual representations of the target devices. A user may interact with the device to cause various activities to be performed with the displayed target devices. For example, the device may display indicia of selection for visually selecting at least one of the target devices. The device may also comprise a touch-sensitive display that may respond to user touch input. For example, a user may draw a gesture on the display including at least one of the target devices, which may cause the device to then perform an activity related to at least the target device included within the drawn gesture. If a wireless connection does not already exist between the device and the target device, a wireless connection may be attempted.

In at least one embodiment, a device for visualized device interactivity management may comprise, for example, at least a communication module, a user interface module and a visual management module (VMM). The communication module may be to interact with at least one target device. The VMM may be to receive an advertising signal from the at least one target device via the communication module, to determine a relative location for the at least one target device, to cause a display in the user interface module to present a visual representation of the at least one target device and to cause the display to present data for the target device corresponding to the visual representation, wherein the target device data is based on the advertisement signal.

For example, in determining a relative location for the at least one target device the VMM may be to at least determine a direction from which the advertising signal was received. The advertising signal may comprise location data indicating at least one of an absolute or relative location for the at least one target device, and the VMM may be to determine the relative location also based on the location data. The VMM may further be to cause the display to update the presentation of the target device data to compensate for changes in the relative location or device orientation determined based on at least one of the advertising signal or sensor data received in the visual management module from at least one sensor in the user interface module.

The VMM may further be to determine if a wireless connection has already been established with the at least one target device based at least on the advertising signal, and if it is determined that a wireless connection has not already been established with the at least one target device, to cause the communication module to attempt to establish a wireless connection with the at least one target device. In at least one embodiment, the display may further be to display indicia for selection, and the visual management module is to perform an activity involving a target device corresponding to a visual representation identified by the indicia for selection when an input is determined to have occurred by the user interface module.

In the same or a different embodiment, the display may be touch sensitive and the visual management module is further to perform an activity based on a touch input sensed by the display. The VMM may further be to interpret a touch-based gesture drawn on the display, the touch-based gesture being drawn over the at least one target device to indicate an activity to be performed involving the at least one target device. The VMM may further be to perform the activity involving the at least one target device over which the touch-based gesture was drawn based on the interpretation of the touch-based gesture. Consistent with the present disclosure, and example method for visualized device interactivity management may comprise receiving an advertising signal in a device from the at least one target device, determining a relative location for the at least one target device, causing a visual representation of the at least one target device to be presented on a display in the device and causing the display to present data for the target device corresponding to the visual representation, wherein the target device data is based on at least the advertisement signal.

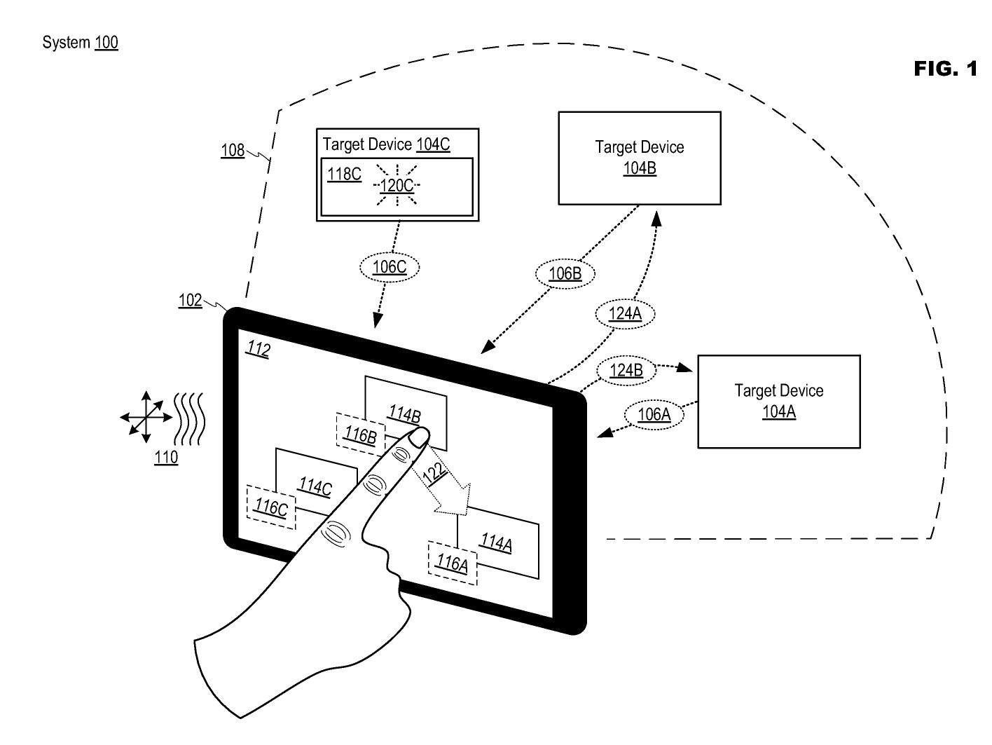

FIG. 1 illustrates an example system for visualized device interactivity management in accordance with at least one embodiment of the present disclosure. System 100 may comprise, for example, at least device 102, target device 104A, target device 104B and target device 104C (collectively “target devices 104A . . . C”). Only target devices 104A . . . C are shown in system 100 to maintain clarity, however, embodiments consistent with the present disclosure are not limited to only three target devices 104 A . . . C, and may involve any amount of target devices 104A . . . C.

Examples of device 102 may comprise, but are not limited to, a mobile communication device such as a cellular handset or smartphone based on the Android® OS and/or Chrome OS® from the Google Corporation, iOS® and/or Mac® OS from the Apple Corporation, Windows® OS from the Microsoft Corporation, Tizen® OS from the Linux Foundation, Firefox® OS from the Mozilla Project, Blackberry® OS from the Blackberry Corporation, Palm® OS from the Hewlett-Packard Corporation, Symbian® OS from the Symbian Foundation, etc., a mobile computing device such as a tablet computer like an iPad® from the Apple Corporation, Nexus® from the Google Corporation, Surface® from the Microsoft Corporation, Galaxy Tab® from the Samsung Corporation, Kindle Fire® from the Amazon Corporation, etc., an Ultrabook® including a low-power chipset manufactured by Intel Corporation, a netbook, a notebook, a laptop, a palmtop, etc., a wearable device such as a wristwatch form factor computing device like the Galaxy Gear® from Samsung, an eyewear form factor computing device/user interface like Google Glass® from the Google Corporation, a typically stationary computing device such as a desktop computer, a smart television, small form factor computing solutions (e.g., for space-limited applications, TV set-top boxes, etc.) like the Next Unit of Computing (NUC) platform from the Intel Corporation, etc. While device 102 may be any of the above example devices, a typical usage scenario may involve device 102 being a smart phone or tablet computer. Device 102 may be pictured or described herein using these example devices to provide a readily comprehensible context for understanding various embodiments consistent with the present disclosure.

Examples of target devices 104A . . . C may include the above examples set forth in regard to device 102, and may also comprise wireless-enabled devices not usually including substantial data processing resources referenced generally herein as “peripherals.” Examples of peripherals may include, but are not limited to, typical computer peripheral devices such as wireless-enabled printers, external data storage devices (e.g., hard disk drive, solid state drive, etc.), user interface devices such as wireless-enabled keyboards, pointing devices (e.g., mice), etc., wearable devices such as wireless-enabled headsets/earpieces, wristwatch format devices, eyewear format devices, etc., presentation devices such as wireless-enabled speakers, headphones, monitors, immersive headsets, etc.

In general, device 102 may be employed to “visualize” a situation wherein a user desires to configure device 102 to interact with at least one of target devices 104A . . . C and/or for target devices 104A . . . C to interact with each other. As referenced herein, to “visualize” may comprise presenting a visual representation of target devices 104A . . . C, wherein the visual representation may be manipulated to cause various activities to be performed. Examples of activities that may be performed may include, but are not limited to, wireless connection establishment, file transfer over the wireless connection, streaming multimedia data (e.g., text, audio and/or video) over the wireless connection, etc. In an example of operation, initially an application to visualize device interactivity and management may be initiated on device 102. The application may be activated by user interaction with device 102, by another application on device 102 requiring interaction with at least one of target devices 104A . . . C, by any of target devices 104A . . . C being sensed in proximity to device 102 (e.g., by receiving a wireless signals from target devices 104A . . . C), etc.

Device 102 may then receive wireless advertising signal 106A from target device 104A, wireless advertising signal 106B from target device 104B, wireless advertising signal 106C from target device 104AC (collectively “advertising signals 106A . . . C). Advertising signals 106A . . . C may be invitations to establish a connection, or if already connected to device 102, signals that used to maintain the connection. Advertising signals 106A . . . C may comprise, for example, data that identifies target devices 104A . . . C, connectivity data (e.g., how a device may communicate), security data (e.g., whether a device is open to any connection or secured), etc. Device 102 may then utilize at least advertising signals 106A . . . C to determine relative locations for target devices 104A . . . C (e.g., by determining the direction from which each of advertising signals 106A . . . C was received). For example, the direction of arrival of advertising signals 106A . . . C may be determined utilizing a multi-antenna system in device 102 that estimates the direction of arrival based on timing differences between when each advertising signal 106A . . . C is received at each antenna. As referenced herein, “relative locations” may be positions of target devices 104A . . . C with respect to device 102. For example, the relative locations for target devices 104A . . . C may comprise at least azimuth (e.g., horizontal) and elevation (e.g., vertical) components relative to a coordinate system defined by a field of view for video capture 108. In at least one embodiment, relative locations may be based on first determining absolute locations (e.g., based on a fixed coordinate system such as the magnetic compass headings, longitude and latitude, etc.) for each of target devices 104A . . . C and/or device 102, and then determining relative locations based on the absolute location(s). Device 102 may also utilize at least one of sensors 110 (e.g., a Global Positioning System (GPS) receiver, at least one wireless signal receiver/transceiver, etc.) to aid in determining relative locations for target devices 104A . . . C. Consistent with the present disclosure, if target devices 104A . . . C comprise resources usable for positioning, such as any of example sensors 110 mentioned above in regard to device 102, then relative locations may be determined “collaboratively” between device 102 and target devices 104A . . . C. For example, advertising signals 106A . . . C may further comprise location data for target devices 104A . . . C. Device 102 may utilize the location information provided in advertising signals 106A . . . C, along with advertising signals 106A . . . C themselves and/or data from sensors 110, to determine the relative locations of target devices 104A . . . C.

Device 102 may then capture image and/or video data, as shown at 108, for presentation on display 112 in device 102 (e.g., using a video capture device such as a camera). Accordingly, visual representation 114A may correspond to target device 104A, visual representation 114B may correspond to target device 104B and visual representation 114C may correspond to target device 104C (collectively “visual representations 114A . . . C”). Initially, device may know which visual representation 114A . . . C corresponds to which target device 104A . . . C based at least on the previously determined relative locations. Device 102 may also utilize the relative locations determined for each of target devices 104A . . . C to present target device data on display 112. For example, target device data 116A may be presented corresponding to visual representation 114A, target device data 116B may be presented corresponding to visual representation 114B and target device data 116C may be presented corresponding to visual representation 114C (collectively “target device data 116A . . . C). In at least one embodiment, target device data 116A . . . C may be presented superimposed on images/video already presented on display 112 in an orientation that touches, overlays, is adjacent to, etc. each corresponding visual representation 114A . . . C (e.g., based on the relative locations determined for target devices 104A . . . C). Alternatively, target device data 116A . . . C may pop up on display 112 when visual representations 114A . . . C are selected (e.g., touched). In general, target device data 116A . . . C may include data useful for determining whether to interact with target devices 104A . . . C. For example, target device data 116A . . . C may comprise at least one of target device identity, available functionality, available communication mediums, security provisions, etc. In at least one embodiment, target device data 116A . . . C may include an indication of confidence that each target device data 116 A . . . C is displayed corresponding to the correct visual representation 114A . . . C. The confidence may vary depending on, for example, the strength of advertising signals 106A . . . C received by device 102, interference in the environment in which device 102 and target devices 104A . . . C are operating, motion and/or reorientation that may have occurred in device 102 and/or target devices 104A . . . C during the reception of advertising signals 106A . . . C, etc. that may influence the relative location determination. The confidence indication may comprise, for example, a text-based indication (e.g., 90% confidence), a graphical indication such as a bar indicator, a pie chart, representative indicia (e.g., smiley face, frowning face, etc.) or any combination of these example indicators. In addition to advertising signals 106A . . . C, target device data 116A . . . C may also be determined based on previous interactions between device 102 and target devices 104A . . . C. For example, if utilizing Bluetooth, device 102 may have already been paired with some or all of target devices 104A . . . C, and may already be aware of the identity, connectivity, security, etc. of target devices 104A . . . C.

In at least one embodiment, target devices 104A . . . C may further collaborate with device 102 through a confirmation usable by device 102 to associate visual representations 114A . . . C with target devices 104A . . . C, to confirm previously determined associations, etc. For example, device 102 may send a request (e.g., a pre-connection message) to each target device 104A . . . C to trigger a presentation. As shown in the example of FIG. 1, when target device 104C receives a request, display 118C may present visual confirmation 120C. Visual confirmation 120C may comprise, for example, a code, image, shape, pattern, etc. recognizable to device 102. Visual confirmation 120C may be presented just long enough for device 102 to recognize within video capture 108 (e.g., less than a second). Device 102 may then associate visual representation 114C with target device 104C (e.g., to which the request was sent) based on visual confirmation 120C. While confirmation 120C is illustrated in FIG. 1 as being visual, other types of confirmation may also be employed such as an audible confirmation (e.g., for target devices 104A . . . C without a display) or another type of confirmation that may be sensed by device 102 (e.g., infrared, etc.).

As device 102 moves, visual representations 114A . . . C will change position on display 112. In at least one embodiment, device 102 may employ at least one sensor 110 to update how target device data 116A . . . C is presented on display 112. For example, sensors 110 configured to sense orientation, motion (e.g., speed, acceleration, etc.) may determine that device 102 has been moved, a direction in which device 102 has moved, a distance device 102 has moved, etc. The presentation of target device data 116A . . . C may then be updated on display 112 to realign target device data 116A . . . C with the corresponding visual representations 114A . . . C. In addition, the presentation of target device data 116A . . . C may also be updated when a change is sensed in the relative location of any of target devices 104A . . . C

Consistent with the present disclosure, a user may then interact with device 102 to cause an activity to occur involving at least one of target devices 104A . . . C and/or device 102. In the embodiment disclosed in FIG. 1, display 112 may be touch sensitive (e.g., using capacitive touch sensing or another similar technology). Via touch 122, which may include a simple pressing of the user's fingertip on the surface of display 112, drawing a gesture (e.g., a continuous pattern or path drawn on the surface of display 112 with the fingertip of the user), etc., at least one activity involving “touched” visual representations 114A . . . C, corresponding to target devices 104A . . . C, and/or device 102 may be initiated. For example, touching visual representation 114B on display 112 may cause wireless connection establishment to be attempted between device 102 and target device 104B, may cause a user interface to be presented on display 112 requesting the activity to perform, etc. Drawing a line between visual representation 114B and visual representation 114A (e.g., as shown in FIG. 1) may cause messages 124A and 124B to be transmitted to at least target devices 104B and 104A to, for example, cause connection establishment between target devices 104B and 104A to be attempted, if necessary, and for a file transfer activity to be initiated. The initialization of some activities, like a file transfer, may cause a user interface screen to then be presented on display 112 allowing the user to see the files available for transfer, to select at least one file for transfer, etc. Other activities may cause other user interfaces to be displayed such as, for example, a device configuration interface, volume controls for controlling a wireless speaker, TV-type controls for controlling a television, media selection controls for a media player, etc.

If a connection is not already established between device 102 and/or any target devices 104A . . . C involved in an activity, the establishment of a wireless connection may be attempted. During the attempt security warnings may be displayed if connection is being attempted to an unsecured target device 104A . . . C. Moreover, the user of device 102 may be notified (e.g., via a message presented on display 112, an audible alert, haptic feedback, etc.) of any failed attempt to establish a wired connection. Any changes of device status due to successful or failed activities may be presented as an update to target device data 116A . . . C (e.g., including a visual indicator to highlight the change). For example, one or both of target device data 116B and 116A may be updated to reflect that target device 104A is in the process of receiving a file from target device 104B, is playing media being provided by (e.g., streaming from) target device 104B, etc.

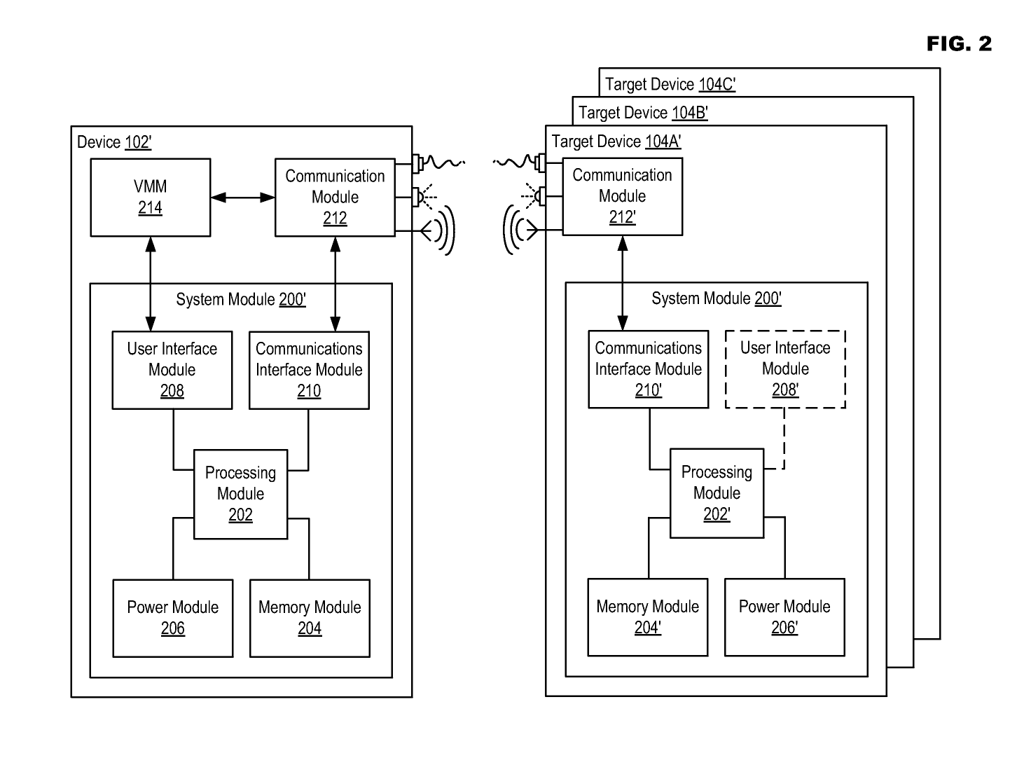

FIG. 2 illustrates example configurations for a device and at least one target device in accordance with at least one embodiment of the present disclosure. Device 102′ and/or target devices 104A′ . . . C′ may be capable of performing example functionality such as disclosed in FIG. 1. However, device 102′ and/or target devices 104A′ . . . C′ are meant only as examples of apparatuses that may be usable in embodiments consistent with the present disclosure, and are not meant to limit these various embodiments to any particular manner of implementation.

Device 102′ may comprise, for example, system module 200 configured to manage device operations. System module 200 may include, for example, processing module 202, memory module 204, power module 206, user interface module 208 and communication interface module 210. Device 102′ may also communication module 212 and VMM 214. While communication module 212 and VMM 214 have been shown as separate from system module 200, the example implementation illustrated in FIG. 2 has been provided merely for the sake of explanation. Some or all of the functionality associated with communication module 212 and/or VMM 214 may be incorporated into system module 200.

In device 102′, processing module 202 may comprise one or more processors situated in separate components, or alternatively, one or more processing cores embodied in a single component (e.g., in a System-on-a-Chip (SoC) configuration) and any processor-related support circuitry (e.g., bridging interfaces, etc.). Example processors may include, but are not limited to, various x86-based microprocessors available from the Intel Corporation including those in the Pentium, Xeon, Itanium, Celeron, Atom, Quark, Core i-series, Core M-series product families, Advanced RISC (e.g., Reduced Instruction Set Computing) Machine or “ARM” processors, etc. Examples of support circuitry may include chipsets (e.g., Northbridge, Southbridge, etc. available from the Intel Corporation) configured to provide an interface through which processing module 202 may interact with other system components that may be operating at different speeds, on different buses, etc. in device 102′. Some or all of the functionality commonly associated with the support circuitry may also be included in the same physical package as the processor (e.g., such as in the Sandy Bridge family of processors available from the Intel Corporation).

Processing module 202 may be configured to execute various instructions in device 102′. Instructions may include program code configured to cause processing module 202 to perform activities related to reading data, writing data, processing data, formulating data, converting data, transforming data, etc. Information (e.g., instructions, data, etc.) may be stored in memory module 204. Memory module 204 may comprise random access memory (RAM) or read-only memory (ROM) in a fixed or removable format. RAM may include volatile memory configured to hold information during the operation of device 102′ such as, for example, static RAM (SRAM) or Dynamic RAM (DRAM). ROM may include non-volatile (NV) memory modules configured based on BIOS, UEFI, etc. to provide instructions when device 102′ is activated, programmable memories such as electronic programmable ROMs (EPROMS), Flash, etc. Other fixed/removable memory may include, but are not limited to, magnetic memories such as, for example, floppy disks, hard drives, etc., electronic memories such as solid state flash memory (e.g., an embedded multimedia card (eMMC), a solid state drive (SSD), etc.), removable memory cards or sticks (e.g., micro storage device (uSD), USB, etc.), optical memories such as compact disc-based ROM (CD-ROM), Digital Video Disks (DVD), Blu-Ray Disks, etc.

Power module 206 may include internal power sources (e.g., a battery, fuel cell, etc.) and/or external power sources (e.g., electromechanical or solar generator, power grid, external fuel cell, etc.), and related circuitry configured to supply device 102′ with the power needed to operate. User interface module 208 may include hardware and/or software to allow users to interact with device 102′ such as, for example, various input mechanisms (e.g., microphones, switches, buttons, knobs, keyboards, speakers, touch-sensitive surfaces, one or more sensors configured to capture images and/or sense proximity, distance, motion, gestures, orientation, biometric data, etc.) and various output mechanisms (e.g., speakers, displays, lighted/flashing indicators, electromechanical components for vibration, motion, etc.). The hardware supporting user interface module 208 may be incorporated within device 102′ and/or may be coupled to device 102′ via a wired or wireless communication medium.

Communication interface module 210 may be configured to manage packet routing and other control functions for communication module 212, which may include resources configured to support wired and/or wireless communications. In some instances, device 102′ may comprise more than one communication module 212 (e.g., including separate physical interface modules for wired protocols and/or wireless radios) managed by a centralized communication interface module 210. Wired communications may include serial and parallel wired mediums such as, for example, Ethernet, Universal Serial Bus (USB), Firewire, Thunderbolt, Digital Video Interface (DVI), High-Definition Multimedia Interface (HDMI), etc. Wireless communications may include, for example, close-proximity wireless mediums (e.g., radio frequency (RF) such as based on the RF Identification (RFID) or Near Field Communications (NFC) standards, infrared (IR), etc.), short-range wireless mediums (e.g., Bluetooth, WLAN, Wi-Fi, etc.), long-range wireless mediums (e.g., cellular wide-area radio communication technology, satellite-based communications, etc.), electronic communications via sound waves, etc. In one embodiment, communication interface module 210 may be configured to prevent wireless communications that are active in communication module 212 from interfering with each other. In performing this function, communication interface module 210 may schedule activities for communication module 212 based on, for example, the relative priority of messages awaiting transmission. While the embodiment disclosed in FIG. 2 illustrates communication interface module 210 being separate from communication module 212, it may also be possible for the functionality of communication interface module 210 and communication module 212 to be incorporated into the same module.

In at least one embodiment, VMM 214 may comprise hardware and/or software that may be configured to interact with at least user interface module 212 and communication module 212. In an example of operation, VMM 214 may utilize communication module 212 to receive at least advertising signals 106A . . . C from target devices 104A′ . . . C′. As illustrated in FIG. 2, example target devices 104A′ . . . C′ may comprise modules 200′ to 212′ that provide similar functionality to that described with respect to device 102′. However, any of modules 200′ to 212′ in target devices 104A′ . . . C′ may be modified, omitted and/or new modules may be introduced based on the configuration of target devices 104A′. . . C′. For example, user interface module 208′ may be minimized or even omitted in a target device 104A′ . . . C′ when such features are not necessary such as, for example, in a wireless-enabled external data storage device, server, etc. wherein user interface functionality may be provided through another device (e.g., an accessing device, remote client, etc.). VMM 214 may use advertising signals 106A . . . C alone, or along with sensor data (e.g., provided by user interface module 208) to determine relative locations for target devices 104A′ . . . C′. VMM 214 may then cause a capture device (e.g., camera) in user interface module 208 to capture image/video data of target devices 104A′ . . . C′, to present visual representations 114A . . . C on display 112 in user interface module 208, and to further present target device data 116A . . . C corresponding to visual representations 114A . . . C on display 112 (e.g., in an adjacent, overlapped, or another visually intuitive manner). VMM 214 may then receive user input from user interface module 208 (e.g., via touch interaction with display 112), may determine at least one activity to be performed based on the user input, and may then cause communication module 212 to transmit messages (e.g., messages 124A and 124B) to any target device 104A′ . . . C′ that may be involved in performing the at least one activity corresponding to the user input.

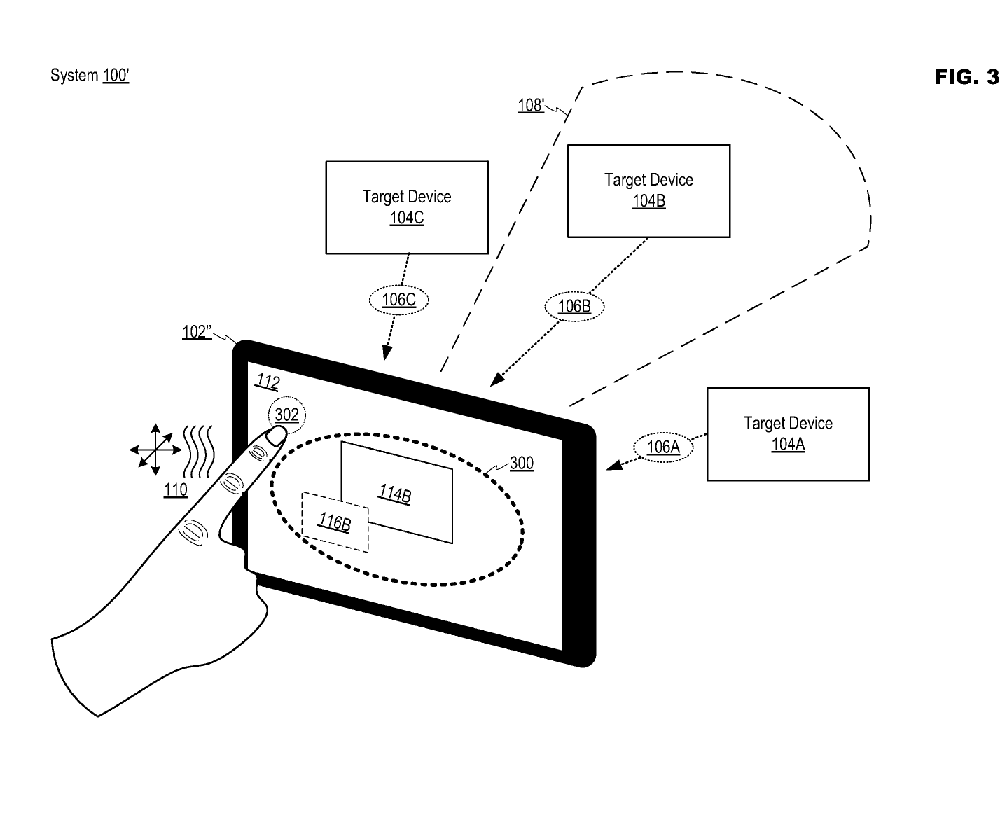

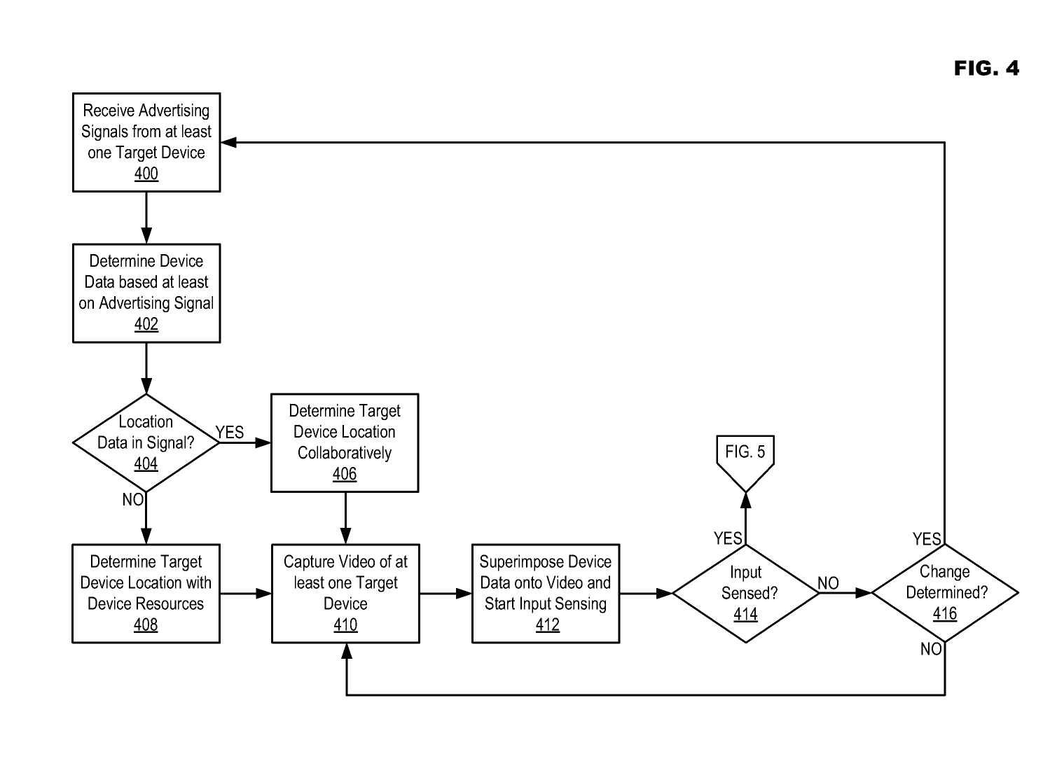

FIG. 3 illustrates an alternative system for visualized device interactivity management in accordance with at least one embodiment of the present disclosure. Any aspect disclosed in FIG. 4 that is substantially similar to FIG. 1 is identified by the same item number. System 100′ may be used in situations where the touch operation disclosed in FIG. 1 is unavailable, inconvenient, etc. For example, system 100′ may be utilized when device 102″ is wearable (e.g., an eyeglass format wearable like Google Glass®, etc.), when device 102″ has a limited field of view 108′, etc. System 100′ may include indicia for selection 300 for selecting at least one target device 104A . . . C with which to perform at least one activity. Indicia of selection 300 may include any visible indicia that may be presented on display 100 that may intuitively “target” target devices 104A . . . C such as, for example, a shape (e.g., square, rectangle, circle, oval, etc.) a crosshairs, brackets, etc. In system 100′, instead of selecting various target devices 104A . . . C by touching display 112, device 102 may be moved so that a visual representation 114A . . . C of a desired target device 104A . . . C appears within the indicia of selection 300 fixed in the center of display 112. Input 302 to device 102 may then trigger selection. While input 302 is disclosed as a touch input to touch sensitive display 112, a variety of other inputs are possible. For example, a user may touch a physical button on device 102″, may utilize a verbal command, may move device 102 in a certain manner so that sensors 110 may recognize the movement as input 302, may make an input gesture with their hand captured by a rear-facing image capture device, etc.

In an example of operation, a user may move device 102″ (e.g., may move their head if device 102″ is a wearable eyeglass format device) to alter the field of view 108′ captured by an image capture device in device 102″. The field of view 108′ may be changed so that the “target” (e.g., visual representation 114B corresponding to target device 104B) is located within indicia of selection 300. While visual representation 114B still appears within indicia of selection 300 on display 112, target device 104B may be selected by providing input 302 to device 102″ via, for example, a touch input to display 112, pressing a physical button on device 102″, the user moving device 102 in a recognized manner, speaking a recognized input word/phrase, making a recognized hand gesture to a rear-facing image capture device in device 102″, etc. If necessary, device 102″ may be moved to change the field of view 108′ so that another visual representation 114A . . . C is presented within indicia of selection 300 for selection (e.g., when two or more target devices 104A . . . C are to be selected to interact with each other and/or with device 102″).

FIG. 4 illustrates example operations for wireless device visualization in accordance with at least one embodiment of the present disclosure. In operation 400 an advertising signal may be received at a device from at least one target device. Device data (e.g., device identity, capability data, security data, etc.) may then be determined based at least on the received advertising signal in operation 402. A determination may then be made in operation 404 as to whether the received advertising signal comprises location data (e.g., based on a location determined by the at least one target device). If in operation 404 it is determined that the advertising signal includes location information, then in operation 406 the relative location of the at least one target device may be determined collaboratively (e.g., using both the location data from the advertising signal and data generated within the device). If in operation 404 it is determined that the advertising signal does not include location information, then in operation 408 the relative location of the at least one target device may be determined using only device resources (e.g., direction of arrival estimation using the received advertising signal and other sensors available in the device).

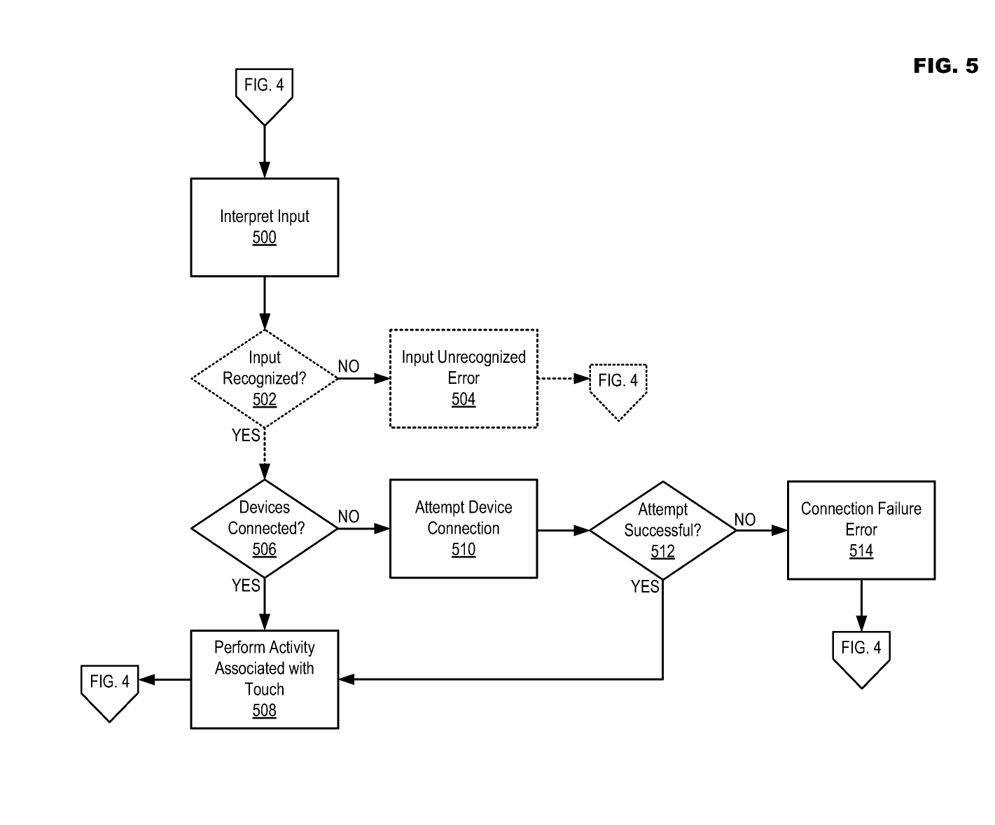

Operation 406 or 408 may be followed by operation 410 wherein an image/video may be captured of the at least one target device. In operation 412, the device data (e.g., based at least on the advertising signal) corresponding to the at least one target device may be superimposed on the image/video including the visual representation of the at least one target device. The device data may be presented as touching, overlaying, adjacent to, etc. the visual representation. Input sensing (e.g., touch sensing, audio sensing, motion sensing, etc.) may then initiate in the device. In operation 414 a determination may be made as to whether an input to has been sensed by the device. If in operation 416 it is determined that an input has not been sensed, then in operation 416 a further determination may be made as to whether a change has been determined either with respect to the device (e.g., the orientation or position of the device) or the position of the at least one target device. A determination of a change in operation 416 may be followed by a return to operation 400 to restart location determination for device 400. A determination in operation 416 that no change has occurred may be followed by a return to operation 410 to continue displayed the visual representation of the at least one target device, the device data, etc. If in operation 414 an input is determined, operations for visualized activity execution may commence in FIG. 5.

FIG. 5 illustrates example operations for visualized activity execution in accordance with at least one embodiment of the present disclosure. Initiating from a determination that an input has been sensed in operation 414 in FIG. 4, in operation 500 the sensed input may be interpreted. In at least one embodiment, the input may be a simple touch or key press. This input may simply be interpreted as an instruction to select, to proceed with an activity, etc. Optional operations 502 to 504 may need to be performed when the device accepts more complex inputs. For example, a more complex input may comprise a gesture drawn on the display of the device, the speaking of a word corresponding to a particular activity, etc. For example, a determination may be made in operation 502 as to whether the sensed input was recognized. If in operation 502 the input is not recognized, then in operation 504 an error may occur. For example, an error notification may be presented to a user of the device (e.g., a visible, audible and/or tactile notification) indicating that the sensed input was not recognized. Operation 504 may be followed by a return to operation 414 in FIG. 4 to await new input (e.g., or a reattempt to enter the previously unrecognized input).

If in operation 502 the sensed input is recognized, a further determination may be made in operation 506 as to whether the devices involved in the activity being requested by the input are already connected (e.g., via wired or wireless link). If in operation 506 it is determined that the devices are already connected, then in operation 508 the activity requested by the input may be performed. Operation 504 may be followed by a return to operation 414 in FIG. 4 to await new input. If in operation 506 it is determined that the devices involved in the requested activity are not already connected, then in operation 510 an attempt may be made to establish a wireless connection between the involved devices. A determination may then be made in operation 512 as to whether the attempt was successful. If in operation 512 it is determined that the attempt was successful, then in operation 508 the requested activity may be performed. If in operation 512 it is determined that the attempt to establish the connection between the devices has failed, then in operation 514 an error may occur. For example, a notification (e.g., visible, audible and/or tactile) may be presented to the user of the device regarding the connection failure. Operation 514 may then be followed by a return to operation 414 in FIG. 4 to await new input.

While FIGS. 4 and 5 illustrate operations according to various embodiments, it is to be understood that not all of the operations depicted in FIGS. 4 and 5 are necessary for other embodiments. Indeed, it is fully contemplated herein that in other embodiments of the present disclosure, the operations depicted in FIGS. 4 and 5, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, the present disclosure is directed to a visualized device interactivity management system. A device may display visual representations of target devices with which wireless interaction is possible. Advertising signals may be received from the target devices, the advertising signal being used to determine target device location and may also include target device data that may overlay the visual representations of the target devices. A user may interact with the device to cause activities to be performed with the target devices. For example, the device may display indicia of selection for visually selecting at least one of the target devices. The device may also comprise a touch-sensitive display. For example, a user may draw a gesture on the display including at least one of the target devices, which may cause the device to then perform an activity related to at least the target devices included within the drawn gesture.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a system for visualized device interactivity management, as provided below.

According to example 1 there is provided a device for visualized device interactivity management. The device may comprise a communication module to interact with at least one target device, a user interface module and a visual management module to receive an advertising signal from the at least one target device via the communication module, determine a relative location for the at least one target device, cause a display in the user interface module to present a visual representation of the at least one target device and cause the display to present data for the target device corresponding to the visual representation, wherein the target device data is based on the advertisement signal.

Example 2 may include the elements of example 1, wherein in determining a relative location for the at least one target device the visual management module is to at least determine a direction from which the advertising signal was received.

Example 3 may include the elements of example 2, wherein the advertising signal comprises location data indicating at least one of an absolute or relative location for the at least one target device, and the visual management module is to determine the relative location also based on the location data.

Example 4 may include the elements of any of examples 1 to 3, wherein in determining a relative location for the at least one target device the visual management module is to transmit a request to the at least one target device, capture a confirmation generated by the at least one target device and associate the visual representation of the at least one target device with the confirmation captured from the at least one target device.

Example 5 may include the elements of example 4, wherein the confirmation is a visual confirmation captured by a camera in the user interface module.

Example 6 may include the elements of any of examples 1 to 5, wherein the visual management module is further to cause the display to update the presentation of the target device data to compensate for changes in the relative location or device orientation determined based on at least one of the advertising signal or sensor data received in the visual management module from at least one sensor in the user interface module.

Example 7 may include the elements of any of examples 1 to 6, wherein the target device data comprises at least one of target device identity, available functionality, available communication mediums or security provisions.

Example 8 may include the elements of any of examples 1 to 7, wherein the target device data comprises at least an indication of confidence that the target device data is presented corresponding to the correct visual representation.

Example 9 may include the elements of any of examples 1 to 8, wherein the visual management module is further to determine if a wireless connection has already been established with the at least one target device based at least on the advertising signal, and if it is determined that a wireless connection has not already been established with the at least one target device, to cause the communication module to attempt to establish a wireless connection with the at least one target device.

Example 10 may include the elements of any of examples 1 to 9, wherein the display is further to display indicia for selection, and the visual management module is to perform an activity involving a target device corresponding to a visual representation identified by the indicia for selection when an input is determined to have occurred by the user interface module.

Example 11 may include the elements of any of examples 1 to 10, wherein the display is touch sensitive and the visual management module is further to perform an activity based on a touch input sensed by the display.

Example 12 may include the elements of example 11, wherein the visual management module is further to interpret a touch-based gesture drawn on the display, the touch-based gesture being drawn over the at least one target device to indicate an activity to be performed involving the at least one target device.

Example 13 may include the elements of example 12, wherein the visual management module is further to perform the activity involving the at least one target device over which the touch-based gesture was drawn based on the interpretation of the touch-based gesture.

Example 14 may include the elements of any of examples 11 to 13, wherein the visual management module is further to interpret a touch-based gesture drawn on the display, the touch-based gesture being drawn over the at least one target device to indicate an activity to be performed involving the at least one target device and perform the activity involving the at least one target device over which the touch-based gesture was drawn based on the interpretation of the touch-based gesture.

According to example 15 there is provided a method for visualized device interactivity management. The method may comprise receiving an advertising signal in a device from the at least one target device, determining a relative location for the at least one target device, causing a visual representation of the at least one target device to be presented on a display in the device and causing the display to present data for the target device corresponding to the visual representation, wherein the target device data is based on at least the advertisement signal.

Example 16 may include the elements of example 15, wherein determining a relative location for the at least one target device comprises determining a direction from which the advertising signal was received.

Example 17 may include the elements of example 16, wherein the advertising signal comprises location data indicating at least one of an absolute or relative location for the at least one target device, the relative location being determined also based on the location data.

Example 18 may include the elements of any of examples 15 to 17, wherein determining a relative location for the at least one target device comprises transmitting a request to the at least one target device, capturing a confirmation generated by the at least one target device and associating the visual representation of the at least one target device with the confirmation captured from the at least one target device.

Example 19 may include the elements of example 18, wherein the confirmation is a visual confirmation captured by a camera in the user interface module.

Example 20 may include the elements of any of examples 15 to 19, and may further comprise causing the display to update the presentation of the target device data to compensate for changes in the relative location or device orientation determined based on at least one of the advertising signal or sensor data received from at least one sensor in the device.

Example 21 may include the elements of any of examples 15 to 20, wherein the target device data comprises at least one of target device identity, available functionality, available communication mediums or security provisions.

Example 22 may include the elements of any of examples 15 to 21, wherein the target device data comprises at least an indication of confidence that the target device data is presented corresponding to the correct visual representation.

Example 23 may include the elements of any of examples 15 to 22, and may further comprise determining if a wireless connection has already been established with the at least one target device based at least on the advertising signal, and if it is determined that a wireless connection has not already been established with the at least one target device, causing the establishment of a wireless connection with the at least one target device to be attempted.

Example 24 may include the elements of any of examples 15 to 23, and may further comprise displaying indicia for selection and performing an activity involving a target device corresponding to a visual representation identified by the indicia for selection when an input is determined to have occurred.

Example 25 may include the elements of any of examples 15 to 24, and may further comprise performing an activity based on a touch input sensed by the display.

Example 26 may include the elements of example 25, and may further comprise interpreting a touch-based gesture drawn on the display, the touch-based gesture being drawn over the at least one target device to indicate an activity to be performed involving the at least one target device and performing the activity involving the at least one target device over which the touch-based gesture was drawn based on the interpretation of the touch-based gesture.

According to example 27 there is provided a system including at least a device and at least one target device, the system being arranged to perform the method of any of the above examples 15 to 26.

According to example 28, there is provided a chipset arranged to perform the method of any of the above examples 15 to 26.

According to example 29 there is provided at least one machine readable medium comprising a plurality of instructions that, in response to be being executed on a computing device, cause the computing device to carry out the method according to any of the above examples 15 to 26.

According to example 30 there is provided at least one device configured for visualized device interactivity management, the at least one device being arranged to perform the method of any of the above examples 15 to 26.

According to example 31 there is provided a system for visualized device interactivity management. The system may comprise means for receiving an advertising signal in a device from the at least one target device, means for determining a relative location for the at least one target device, means for causing a visual representation of the at least one target device to be presented on a display in the device and means for causing the display to present data for the target device corresponding to the visual representation, wherein the target device data is based on at least the advertisement signal.

Example 32 may include the elements of example 31, wherein the means for determining a relative location for the at least one target device comprise means for determining a direction from which the advertising signal was received.

Example 33 may include the elements of example 32, wherein the advertising signal comprises location data indicating at least one of an absolute or relative location for the at least one target device, the relative location being determined also based on the location data.

Example 34 may include the elements of any of examples 31 to 33, wherein the means for determining a relative location for the at least one target device comprise means for transmitting a request to the at least one target device, means for capturing a confirmation generated by the at least one target device and means for associating the visual representation of the at least one target device with the confirmation captured from the at least one target device.

Example 35 may include the elements of example 34, wherein the confirmation is a visual confirmation captured by a camera in the user interface module.

Example 36 may include the elements of any of examples 31 to 35, and may further comprise means for causing the display to update the presentation of the target device data to compensate for changes in the relative location or device orientation determined based on at least one of the advertising signal or sensor data received from at least one sensor in the device.

Example 37 may include the elements of any of examples 31 to 36, wherein the target device data comprises at least one of target device identity, available functionality, available communication mediums or security provisions.

Example 38 may include the elements of any of examples 31 to 37, wherein the target device data comprises at least an indication of confidence that the target device data is presented corresponding to the correct visual representation.

Example 39 may include the elements of any of examples 31 to 38, and may further comprise means for determining if a wireless connection has already been established with the at least one target device based at least on the advertising signal and means for, if it is determined that a wireless connection has not already been established with the at least one target device, causing the establishment of a wireless connection with the at least one target device to be attempted.

Example 40 may include the elements of any of examples 31 to 39, and may further comprise means for displaying indicia for selection and means for performing an activity involving a target device corresponding to a visual representation identified by the indicia for selection when an input is determined to have occurred.

Example 41 may include the elements of any of examples 31 to 40, and may further comprise means for performing an activity based on a touch input sensed by the display.

Example 42 may include the elements of example 41, and may further comprise means for interpreting a touch-based gesture drawn on the display, the touch-based gesture being drawn over the at least one target device to indicate an activity to be performed involving the at least one target device and means for performing the activity involving the at least one target device over which the touch-based gesture was drawn based on the interpretation of the touch-based gesture.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A device for visualized device interactivity management, comprising:
a communication module to interact with at least one target device;
a user interface module; and
a visual management module to:
receive an advertising signal from the at least one target device via the communication module;
determine a relative location for the at least one target device;
cause a display in the user interface module to present a visual representation of the at least one target device; and
cause the display to present data for the target device corresponding to the visual representation, wherein the target device data is based on the advertisement signal.

2. The device of claim 1, wherein in determining a relative location for the at least one target device the visual management module is to at least determine a direction from which the advertising signal was received.

3. The device of claim 2, wherein the advertising signal comprises location data indicating at least one of an absolute or relative location for the at least one target device, and the visual management module is to determine the relative location also based on the location data.

4. The device of claim 1, wherein the visual management module is further to cause the display to update the presentation of the target device data to compensate for changes in the relative location or device orientation determined based on at least one of the advertising signal or sensor data received in the visual management module from at least one sensor in the user interface module.

5. The device of claim 1, wherein the visual management module is further to determine if a wireless connection has already been established with the at least one target device based at least on the advertising signal, and if it is determined that a wireless connection has not already been established with the at least one target device, to cause the communication module to attempt to establish a wireless connection with the at least one target device.

6. The device of claim 1, wherein the display is further to display indicia for selection, and the visual management module is to perform an activity involving a target device corresponding to a visual representation identified by the indicia for selection when an input is determined to have occurred by the user interface module.

7. The device of claim 1, wherein the display is touch sensitive and the visual management module is further to perform an activity based on a touch input sensed by the display.

8. The device of claim 7, wherein the visual management module is further to interpret a touch-based gesture drawn on the display, the touch-based gesture being drawn over the at least one target device to indicate an activity to be performed involving the at least one target device.

9. The device of claim 8, wherein the visual management module is further to perform the activity involving the at least one target device over which the touch-based gesture was drawn based on the interpretation of the touch-based gesture.

10. A method for visualized device interactivity management, comprising:
receiving an advertising signal in a device from the at least one target device;
determining a relative location for the at least one target device;
causing a visual representation of the at least one target device to be presented on a display in the device; and
causing the display to present data for the target device corresponding to the visual representation, wherein the target device data is based on at least the advertisement signal.

11. The method of claim 10, wherein determining a relative location for the at least one target device comprises determining a direction from which the advertising signal was received.

12. The method of claim 11, wherein the advertising signal comprises location data indicating at least one of an absolute or relative location for the at least one target device, the relative location being determined also based on the location data.

13. The method of claim 10, further comprising:
causing the display to update the presentation of the target device data to compensate for changes in the relative location or device orientation determined based on at least one of the advertising signal or sensor data received from at least one sensor in the device.

14. The method of claim 10, further comprising:
determining if a wireless connection has already been established with the at least one target device based at least on the advertising signal; and
if it is determined that a wireless connection has not already been established with the at least one target device, causing the establishment of a wireless connection with the at least one target device to be attempted.

15. The method of claim 10, further comprising:
displaying indicia for selection; and
performing an activity involving a target device corresponding to a visual representation identified by the indicia for selection when an input is determined to have occurred.

16. The method of claim 10, further comprising:
performing an activity based on a touch input sensed by the display.

17. The method of claim 16, further comprising:
interpreting a touch-based gesture drawn on the display, the touch-based gesture being drawn over the at least one target device to indicate an activity to be performed involving the at least one target device; and
performing the activity involving the at least one target device over which the touch-based gesture was drawn based on the interpretation of the touch-based gesture.

18. At least one machine-readable storage medium having stored thereon, individually or in combination, instructions for visualized device interactivity management that, when executed by one or more processors, cause the one or more processors to:
receive an advertising signal in a device from the at least one target device;
determine a relative location for the at least one target device;
cause a visual representation of the at least one target device to be presented on a display in the device; and
cause the display to present data for the target device corresponding to the visual representation, wherein the target device data is based on at least the advertisement signal.

19. The medium of claim 18, wherein the instructions to determine a relative location for the at least one target device comprise instructions to determine a direction from which the advertising signal was received.

20. The medium of claim 19, wherein the advertising signal comprises location data indicating at least one of an absolute or relative location for the at least one target device, the relative location being determined also based on the location data.

21. The medium of claim 18, further comprising, instructions that, when executed by one or more processors, cause the one or more processors to:
cause the display to update the presentation of the target device data to compensate for changes in the relative location or device orientation determined based on at least one of the advertising signal or sensor data received from at least one sensor in the device.

22. The medium of claim 18, further comprising, instructions that, when executed by one or more processors, cause the one or more processors to:
determine if a wireless connection has already been established with the at least one target device based at least on the advertising signal; and
if it is determined that a wireless connection has not already been established with the at least one target device, cause the establishment of a wireless connection with the at least one target device to be attempted.

23. The medium of claim 18, further comprising, instructions that, when executed by one or more processors, cause the one or more processors to:
display indicia for selection; and
perform an activity involving a target device corresponding to a visual representation identified by the indicia for selection when an input is determined to have occurred.

24. The medium of claim 18, further comprising, instructions that, when executed by one or more processors, cause the one or more processors to:
perform an activity based on a touch input sensed by the display.

25. The medium of claim 24, further comprising, instructions that, when executed by one or more processors, cause the one or more processors to:
interpret a touch-based gesture drawn on the display, the touch-based gesture being drawn over the at least one target device to indicate an activity to be performed involving the at least one target device; and
perform the activity involving the at least one target device over which the touch-based gesture was drawn based on the interpretation of the touch-based gesture.
